(19) United States
(12) Patent Application Publication
(10) Pub. No.: US 2008/0098197 A1
(43) Pub. Date: Apr. 24, 2008

(54) Method and System For Address Translation With Memory Windows

(75) Inventors: David F. Craddock, New Paltz, NY (US); Charles S. Graham, Rochester, MN (US); Thomas A. Gregg, Highland, NY (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: International Business Machines Corporation, Armonk, NY (US)

(21) Appl. No.: 11/551,405

(22) Filed: Oct. 20, 2006

(51) Int. Cl. G06F 12/00

(52) U.S. Cl. 711/206

(57) ABSTRACT

Disclosed are a method and system for address translation with memory windows. The method comprises the steps of designating a memory region having a set of virtual addresses, each virtual address having an associated real address; and providing one or more translation tables for translating the virtual addresses to the real addresses; A memory region protection table entry (MRPTE) defines access rights for the memory region, and includes one or more pointers to the one or more translation tables. A memory window is bound to the memory region to provide access to a subset of the virtual addresses. A memory window protection table entry (MWPTE) defines access rights for the memory window, and includes one or more pointers to the one or more translation tables to translate the subset of virtual addresses to real addresses.

### BACKGROUND OF THE INVENTION

1. Field of the Invention

This invention generally relates to memory access in computer systems, and more specifically, to an efficient scheme for address translation within memory windows.

2. Background Art

In a System Area Network (SAN), multiple processors compete for services and access to memory locations in order to write data to or read data from the memory locations. In a SAN, the hardware provides a message passing mechanism, which can be used for Input/Output devices (I/O) and interprocess communications between general computing nodes. Consumers access SAN message passing hardware by posting send/receive messages to send/receive work queues on a SAN channel adapter. The send/receive work queues are assigned to a consumer as a queue pair. Consumers retrieve the results of these messages from a completion queue through SAN send and receive work completions. The source channel adapter takes care of segmenting outbound messages and sending them to the destination. The destination channel adapter takes care of reassembling inbound messages and placing them in the memory space designated by the destination's consumer. Two channel adapter types are present, a host channel adapter (HCA) and a target channel adapter (TCA).

In the operation of a SAN, a common method for controlling a consumer's access to memory is via memory registration. Memory registration mechanisms allow a user on the host to describe a set of virtually contiguous local memory locations or a set of physically contiguous local memory locations in order to allow the channel adapters to access them. A user must register these memory locations, through the operating system kernel of the host computer, before use. A set of contiguous memory locations that have been registered are referred to as a memory region.

The channel adapters maintain protection and address translation tables that support memory region translation. The channel adapters use these tables to validate access rights and to translate virtual addresses to physical addresses.

One type of SAN employs Remote Direct Memory Access (RDMA). RDMA-capable adapters such as InfiniBand HCAs and iWarp RNICs provide the concept of Memory Windows that allow an application to restrict access to a portion of a previously registered Memory Region. The Memory Window defines the bounds and access rights within the Memory Region. The address translation process performed by the adapter is performed on the Memory Region to which the Memory Window is bound.

This address translation process for a Memory Window can be time-consuming, because when a window is accessed, first the Protection Table entry must be fetched for the Memory Region and then the address translation information must be fetched for the Memory Region, which when the region is large (which is typical when using windows) require fetches for each of the levels of the Address Translation Table (AT_Table).

### SUMMARY OF THE INVENTION

An object of this invention is to provide an efficient method and system for address translation with Memory Windows.

Another object of the present invention is to provide address translation information directly in a Memory Window Protection Table Entry.

A further object of the invention is to provide a method and system for address translation of a Memory Window within a Memory Region for access by an I/O adapter.

Generally, the present invention utilizes a mechanism for providing the address translation information directly in a Memory Window Protection Table Entry, and thus avoids several levels of indexing. No additional Address Translation Tables are needed, as the ones from the Memory Region are re-used.

The present invention relates, more specifically, to a method and system for address translation with memory windows. The method comprises the steps of designating a memory region having a set of virtual memory addresses, each of said virtual memory addresses having an associated real memory address; providing one or more address translation tables for translating said virtual memory addresses to the real memory addresses; and providing a memory region protection table entry (MRPTE) defining access rights for the memory region, and including one or more pointers to said one or more address translation tables.

A memory window is bound to said memory region, said memory window providing access to a subset of said set of virtual addresses of the memory region; and a memory window protection table entry (MWPTE) is provided for defining access rights for the memory window. The MWPTE is provided with one or more pointers to said one or more address translation tables to translate said subset of virtual addresses to the real addresses associated with said subset of virtual addresses.

Further benefits and advantages of the invention will become apparent from a consideration of the following detailed description, given with reference to the accompanying drawings, which specify and show preferred embodiments of the invention.

### BRIEF DESCRIPTION OF THE DRAWINGS

FIG. 1 depicts a diagram of a networked computing system in accordance with a preferred embodiment of the invention.

FIG. 2 is a functional block diagram of a host processor node of the computing system of FIG. 1.

FIG. 3 is a diagram of a host channel adapter of the computing system of FIG. 1.

FIG. 4 represents a Memory Window Protection Table Entry.

FIG. 5 represents a Memory Region Protection Table Entry.

FIG. 6 illustrates a Memory Window Address Translation Example in accordance with a preferred embodiment of this invention.

FIG. 7 is a table of memory region page sizes and indices.

### DETAILED DESCRIPTION OF THE PREFERRED EMBODIMENTS

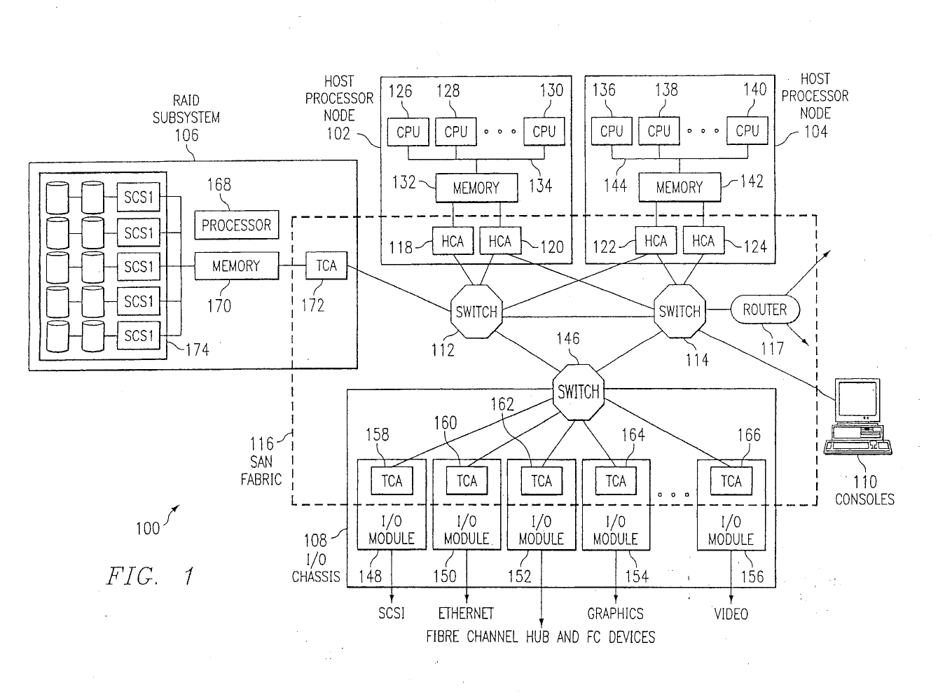

With reference now to the figures and in particular with reference to FIG. 1, a diagram of a networked computing system is illustrated in accordance with a preferred embodiment of the present invention. The distributed computer system represented in FIG. 1 takes the form of a system area network (SAN) 100 and is provided merely for illustrative purposes, and the embodiments of the present invention described below can be implemented on computer systems of numerous other types and configurations. For example, computer systems implementing the present invention can range from a small server with one processor and a few input/output (I/O) adapters to massively parallel supercomputer systems with hundreds or thousands of processors and thousands of I/O adapters. Furthermore, the present invention can be implemented in an infrastructure of remote computer systems connected by an internet or intranet.

SAN 100 is a high-bandwidth, low-latency network interconnecting nodes within the distributed computer system. A node is any component attached to one or more links of a network and forming the origin and/or destination of messages within the network. In the depicted example, SAN 100 includes nodes in the form of host processor node 102, host processor node 104, redundant array independent disk (RAID) subsystem node 106, and I/O chassis node 108. The nodes illustrated in FIG. 1 are for illustrative purposes only, as SAN 100 can connect any number and any type of independent processor nodes, I/O adapter nodes, and I/O device nodes. Any one of the nodes can function as an endnode, which is herein defined to be a device that originates or finally consumes messages or packets in SAN 100.

SAN 100 may be provided with an error handling mechanism for reliable connection or reliable datagram communication between end nodes of the network.

A message, as used herein, is an application-defined unit of data exchange, which is a primitive unit of communication between cooperating processes. A packet is one unit of data encapsulated by a networking protocol headers and/or trailer. The headers generally provide control and routing information for directing the packets through the SAN. The trailer generally contains control and cyclic redundancy check (CRC) data for ensuring packets are not delivered with corrupted contents.

SAN 100 contains the communications and management infrastructure supporting both I/O and interprocessor communications (IPC) within a distributed computer system. The SAN 100 shown in FIG. 1 includes a switched communications fabric 116, which allows many devices to concurrently transfer data with high-bandwidth and low latency in a secure, remotely managed environment. Endnodes can communicate over multiple ports and utilize multiple paths through the SAN fabric. The multiple ports and paths through the SAN shown in FIG. 1 can be employed for fault tolerance and increased bandwidth data transfers.

The SAN 100 in FIG. 1 includes switch 112, switch 114, switch 146, and router 117. A switch is a device that connects multiple links together and allows routing of packets from one link to another link within a subnet using a small header Destination Local Identifier (DLID) field. A router is a device that connects multiple subnets together and is capable of routing packets from one link in a first subnet to another link in a second subnet using a large header Destination Global Identifier (DGID).

A link may be a full duplex channel between any two-network fabric elements, such as endnodes, switches or routers. Examples of suitable links include, but are not limited to, copper cables, optical cables, and printed circuit copper traces on backplanes and printed circuit boards.

For reliable service types, endnodes, such as host processor endnodes and I/O adapter endnodes, generate request packets and return acknowledgment packets. Switches and routers pass packets along, from the source to the destination. Except for the variant CRC trailer field, which is updated at each stage in the network, switches pass the packets along unmodified. Routers update the variant CRC trailer field and modify other fields in the header as the packet is routed.

In SAN 100 as illustrated in FIG. 1, host processor node 102, host processor node 104, and I/O chassis 108 include at least one channel adapter (CA) to interface to SAN 100. In one embodiment, each channel adapter is an endpoint that implements the channel adapter interface in sufficient detail to source or sink packets transmitted on SAN fabric 116. Host processor node 102 contains channel adapters in the form of host channel adapter 118 and host channel adapter 120. Host processor node 104 contains host channel adapter 122 and host channel adapter 124. Host processor node 102 also includes central processing units 126-130 and a memory 132 interconnected by bus system 134. Host processor node 104 similarly includes central processing units 136-140 and a memory 142 interconnected by a bus system 144.

Host channel adapter 118 provides a connection to switch 112, host channel adapters 120 and 122 provide a connection to switches 112 and 114, and host channel adapter 124 provides a connection to switch 114.

In one embodiment, a host channel adapter is implemented in hardware. In this implementation, the host channel adapter hardware offloads much of central processing unit and I/O adapter communication overhead. This hardware implementation of the host channel adapter also permits multiple concurrent communications over a switched network without the traditional overhead associated with communicating protocols. In one embodiment, the host channel adapters and SAN 100 in FIG. 1 provide the I/O and interprocessor communications (IPC) consumers of the distributed computer system with zero processor-copy data transfers without involving the operating system kernel process, and employs hardware to provide reliable, fault tolerant communications.

As indicated in FIG. 1, router 117 is coupled to wide area network (WAN) and/or local area network (LAN) connections to other hosts or other routers.

The I/O chassis 108 in FIG. 1 includes an I/O switch 146 and multiple I/O modules 148-156. In these examples, the I/O modules take the form of adapter cards. Example adapter cards illustrated in FIG. 1 include a SCSI adapter card for I/O module 148; an adapter card to fiber channel hub and fiber channel-arbitrated loop (FC-AL) devices for I/O module 152; an ethernet adapter card for I/O module 150; a graphics adapter card for I/O module 154; and a video adapter card for I/O module 156. Any known type of adapter card can be implemented. I/O adapters also include a switch in the I/O adapter backplane to couple the adapter cards to the SAN fabric. These modules contain target channel adapters 158-166.

In this example, RAID subsystem node 106 in FIG. 1 includes a processor 168, a memory 170, a target channel adapter (TCA) 172, and multiple redundant and/or a striped storage disk unit 174. Target channel adapter 172 can be a fully functional host channel adapter.

SAN 100 handles data communications for I/O and interprocessor communications. SAN 100 supports high-bandwidth and scalability required for I/O and also supports the extremely low latency and low CPU overhead required for interprocessor communications. User clients can bypass the operating system kernel process and directly access network communication hardware, such as host channel adapters, which enable efficient message passing protocols. SAN 100 is suited to current computing models and is a building block for new forms of I/O and computer cluster communication. Further, SAN 100 in FIG. 1 allows I/O adapter nodes to communicate among themselves or communicate with any or all of the processor nodes in a distributed computer system. With an I/O adapter attached to the SAN 100, the resulting I/O adapter node has substantially the same communication capability as any host processor node in SAN 100.

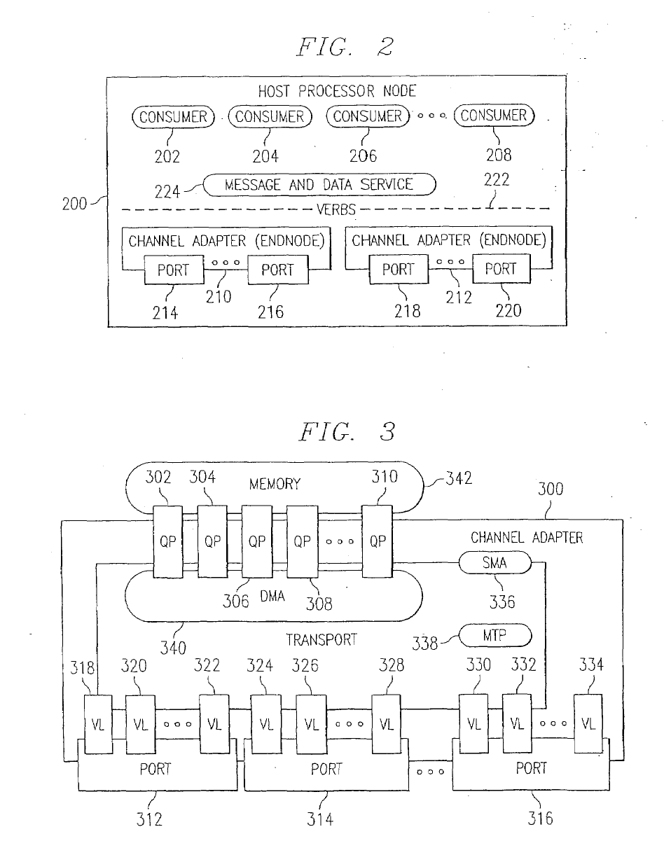

FIG. 2 shows a host processor node 200 as an example of one of the host processor nodes, such as node 102, of FIG. 1. In this example, host processor node 200 includes a set of consumers 202-208, which are processes executing on host processor node 200. Host processor node 200 also includes channel adapter 210 and channel adapter 212. Channel adapter 210 contains ports 214 and 216 while channel adapter 212 contains ports 218 and 220. Each port connects to a link. The ports can connect to one SAN subnet or multiple SAN subnets, such as SAN 100 in FIG. 1. In these examples, the channel adapters take the form of host channel adapters.

Consumers 202-208 transfer messages to the SAN via the verbs interface 222 and message and data service 224. A verbs interface is essentially an abstract description of the functionality of a host channel adapter. An operating system may expose some or all of the verb functionality through its programming interface. Basically, this interface defines the behavior of the host. Additionally, host processor node 200 includes a message and data service 224, which is a higher-level interface than the verb layer and is used to process messages and data received through channel adapter 210 and channel adapter 212. Message and data service 224 provides an interface to consumers 202-208 to process messages and other data.

FIG. 3 is a diagram of a host channel adaptor 300 that may be used in the SAN of FIG. 1. This host channel adapter 300 includes a set of queue pairs (QPs) 302-310, which are used to transfer messages to the host channel adapter ports 312-316. Buffering of data to host channel adapter ports 312-316 is channeled through virtual lanes (VL) 318-334 where each VL has its own flow control. Subnet manager configures channel adapters with the local addresses for each physical port, i.e., the port's LID. Subnet manager agent (SMA) 336 is the entity that communicates with the subnet manager for the purpose of configuring the channel adapter.

Memory translation and protection (MTP) 338 is a mechanism that translates virtual addresses to physical addresses and to validate access rights using memory regions and memory windows. Direct memory access (DMA) 340 provides for direct memory access operations using memory 342 with respect to queue pairs 302-310.

A single channel adapter, such as the host channel adapter 300 shown in FIG. 3, can support thousands of queue pairs. By contrast, a target channel adapter in an I/O adapter typically supports a much smaller number of queue pairs.

Each queue pair consists of a send work queue (SWQ) and a receive work queue. The send work queue is used to send channel and memory semantic messages. The receive work queue receives channel semantic messages. A consumer calls an operating-system specific programming interface, which is herein referred to as verbs, to place Work Requests onto a Work Queue (WQ).

A Remote Direct Memory Access (RDMA) Read Work Request provides a memory semantic operation to read a virtually contiguous memory space on a remote node. A memory space can either be a portion of a Memory Region or portion of a Memory Window. A Memory Region references a previously registered set of virtually contiguous memory addresses defined by a virtual address and length. A Memory Window references a set of virtually contiguous memory addresses, which have been bound to a previously registered region.

The RDMA Read Work Request reads a virtually contiguous memory space on a remote endnode and writes the data to a virtually contiguous local memory space. Similar to the send Work Request, virtual addresses used by the RDMA Read Work Queue Elements (WQE) to reference the local data segments are in the address context of the process that created the local queue pair.

The mechanism that is used to provide the HCA hardware with the information required to change the access rights of a Memory Window is called a Bind Memory Window. A WQE that defines the parameters associated with a Memory Window is placed on a work queue.

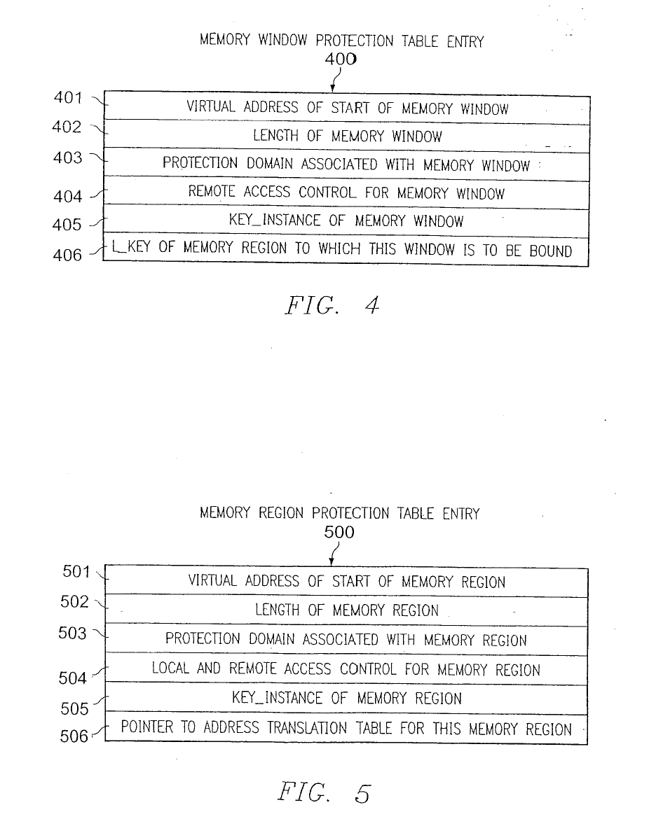

Referring now to FIG. 4, a table illustrating the generic format of the Memory Window PTE is depicted. The Memory Window PTE 400 defines the characteristics of the Memory Window and is used to determine if the Bind Request has the right to modify the characteristics of the Window, as well as determine if a memory access has the required access rights.

The virtual address 401 and length 402 define the bounds of the Memory Window. The Protection Domain 403 is used to correlate the access between the Memory Window, the Memory Region and the Queue Pair associated with the Work Request. The Remote Access Control 404 defines the access rights for this Memory Window (e.g. remote write access is permitted). The Key_Instance 405 is used to control accesses when Windows are re-bound. It is checked when a Bind is processed to see if the consumer has the right to change the Characteristics of the Memory Window. The L_Key 406 of the Memory region is used to access the Memory Region's PTE which defines the characteristics of the Memory Region and also, either directly or indirectly, references the Address Translation Tables that define the virtual-to-real address mappings for the Memory Region.

Referring to FIG. 5, a table illustrating the generic format of the Memory Region PTE is depicted. The Memory Region PTE 500 defines the characteristics of the Memory Region and is used to determine if the Bind Request has the right to access the Memory Region.

The virtual address 501 and length 502 define the bounds of the Memory region. The Memory Window must fall within these bounds. The Protection Domain 503 is used to correlate the access between the Memory Window, the Memory Region and the Queue Pair associated with the Work Request. The Access Control 504 defines the access rights for this Memory Region (e.g. Memory Window binding is permitted). The Key_Instance 505 is used to check if the bind request has the right to access this Memory Region. The Pointer 506 to the Address Translation Table references the Address Translation Table that defines the virtual-to-real address mappings for the Memory Region.

The address translation process for a Memory Window can be time-consuming, because when a window is accessed, first the Protection Table entry must be fetched for the Memory Window and then the protection and address translation information must be fetched for the Memory Region. When the Memory Region is large, which is typical when using Windows, obtaining the needed address translation information requires fetches for each of the levels of AT_Tables.

In accordance with the present invention, a mechanism is used for providing the address translation information directly in the Memory Window Protection Table Entry. The use of this mechanism avoids several levels of indirection, and furthermore, no additional Address Translation Tables are needed as the ones from the memory Region are re-used.

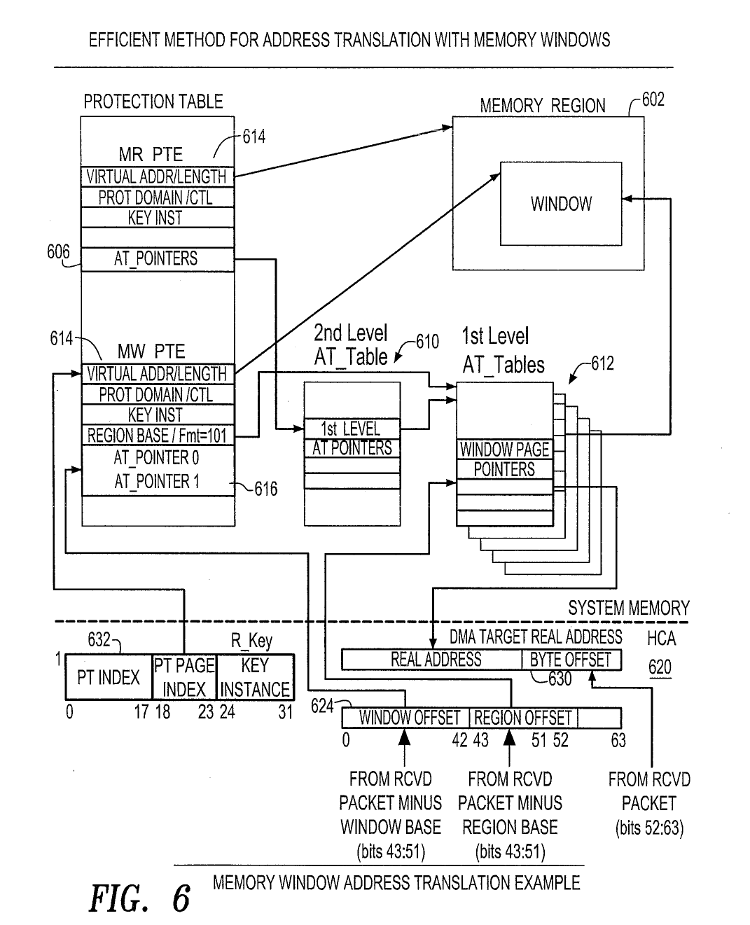

Referring to FIG. 6, an example Memory Region 602 is shown that has a Protection Table Entry (MR PTE) 604 defining the access rights for the region. The MR PTE also contains AT_Pointers 606 that reference the 2^{nd} level AT_Table 610 that contains entries that point to 1^{st} level AT_Tables 612 that contain the real addresses of the pages that make up the Memory Region. The Memory Window has its own MW PTE 614 that defines its access rights. This MW PTE contains format bits that define the number of levels of AT_Tables that are needed for the size Memory Window and the base address of the Memory Window and of the Memory Region. It also contains AT_Pointers 616 that point to the entries that provide the address translation information for the memory window. In accordance with the present invention, the format bits, the memory region base address, and the AT_Pointers are added to the MW PTE depicted in FIG. 4. The MW PTE is built by the adapter when the memory window is bound to the Memory Region. All the information necessary to build the MW PTE is contained in the bind Memory Window WQE and the memory region PTE to which the window is bound.

The address translation process that is used for a remote access within a memory window depends on the AT_Pointers contained in the Memory Window PTE. The format is specified by the AT_Pointer Format bits in the MW PTE.

If the AT_Pointer Format bits are b′0xx′, the address translation process is identical to that for Memory Regions and all the Memory Region AT_Tables are used. The low order bits indicate the number of levels of address translation required and the base address of the memory region is contained in the MW PTE.

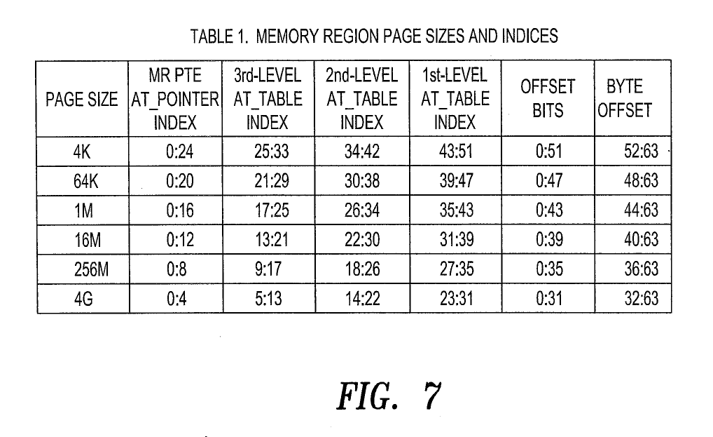

If the AT_Pointer format bits are b′1xx′, the AT_Pointer(s) contained in the MW PTE reference the level of AT_Table indicated by the two low order bits. This provides the capability for windows that occupy less pages than the memory region to which they belong, to avoid one or more levels of the address translation process. In these cases, the indexing into the AT_Tables is performed in the same way as it is performed for memory regions, using the appropriate bits from the memory region offset (SEE Table 1 in FIG. 7). The high order bits that are not used to index into AT_Tables are used to index into the MW PTE AT_Pointers, but the offset used as an index in this case is calculated using the Memory Window starting address contained in the MW PTE instead of the region base address.

There are no AT_Tables maintained specifically for a Memory Window. All the AT_Tables that were set up for the memory region to which the window belongs, remain unchanged.

An example of a Memory Window and its associated tables and structures is given in FIG. 6. In this example, the AT_Pointer format is b′ 101′, indicating that the AT_Pointer in the MW PTE references a 1^{st}-level AT_Table. Note that this allows the HCA 620 to bypass the 2^{nd}-level AT_Table when accessing this window. Bits 43 to 51 of the memory region base address 624 are subtracted from bits 43 to 51 of the target address 630, to obtain the index 632 into the 1^{st}-level AT_Table. In this example, the window spans two 1^{st}-level AT_Tables, so two AT_Pointers are required in the MW PTE, to reference each of these tables. Bits zero to 42 of the window base address 624 are subtracted from bits zero to 42 of the target address 630 to obtain the index into these AT_Pointers (note that the high order bits will be all zeros, as the previous standard protection checks guaranteed that the access was within the bounds of the Memory Window).

It should be noted that the present invention, or aspects of the invention, can be embodied in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

What is claimed is:

1. A method for address translation with memory windows, comprising the steps of:
designating a memory region having a set of virtual memory addresses, each of said virtual memory addresses having an associated real memory address;
using one or more address translation tables for translating said virtual memory addresses to the real memory addresses;
using a memory region protection table entry (MRPTE) for defining access rights for the memory region, said MRPTE including one or more pointers to said one or more address translation tables;
binding a memory window to said memory region, said memory window providing access to a subset of said set of virtual addresses of the memory region;
using a memory window protection table entry (MWPTE) for defining access rights for the memory window; and
giving the MWPTE one or more pointers to said one or more address translation tables to translate said subset of virtual addresses to the real addresses associated with said subset of virtual addresses.

2. A method according to claim 1, wherein said one or more address translation tables includes a first level address translation table and a second level address translation table, and further comprising the step of providing the MWPTE with a set of format bits for indicating whether the one or more pointers of the MWPTE point to either said first level address translation table or to said second level address translation table.

3. A method according to claim 2, comprising the further step of using said one or more pointers of the MWPTE to access said first level address translation table if said format bits have a first defined value.

4. A method according to claim 3, comprising the further step of using said one or more pointers of the MWPTE to access said second level address table if said format bits have a second defined value.

5. A method according to claim 1, wherein:
said one or more address translation tables includes a first address translation table and a second address translation table; and
said one or more pointers includes a first pointer pointing to the first translation table and a second pointer pointing to the second translation table.

6. A method according to claim 1, comprising the further step of adding to the MWPTE a base address of the memory region.

7. A system for address translation with memory windows, comprising:
a memory region having a set of virtual memory addresses, each of said virtual memory addresses having an associated real memory address;
one or more address translation tables for translating said virtual memory addresses to the real memory addresses;
a memory region protection table entry (MRPTE) defining access rights for the memory region, and including one or more pointers to said one or more address translation tables;
a memory window bound to said memory region, said memory window providing access to a subset of said set of virtual addresses of the memory region; and
a memory window protection table entry (MWPTE) defining access rights for the memory window, said MWPTE including one or more pointers to said one or more address translation tables to translate said subset of virtual addresses to the real addresses associated with said subset of virtual addresses.

8. A system according to claim 7, wherein said one or more address translation tables includes a first level address translation table and a second level address translation table, and the MWPTE further includes a set of format bits for indicating whether the one or more pointers of the MWPTE point to either said first level address translation table or to said second level address translation table.

9. A system according to claim 8, wherein said one or more pointers of the MWPTE are used to access said first level address translation table if said format bits have a first defined value.

10. A system according to claim 9, wherein said one or more pointers of the MWPTE are used to access said second level address table if said format bits have a second defined value.

11. A system according to claim 7, wherein:
said one or more address translation tables includes a first level address translation table and a second address translation table; and
said one or more pointers includes a first pointer pointing to the first translation table and a second pointer pointing to the second translation table.

12. A system according to claim 7, wherein the MWPTE further includes a base address of the memory region.

13. A program storage device readable by machine, tangibly embodying a program of instructions executable by the machine to perform method steps for address translation with memory windows, the method steps comprising:
designating a memory region having a set of virtual memory addresses, each of said virtual memory addresses having an associated real memory address;
using one or more address translation tables for translating said virtual memory addresses to the real memory addresses;
using a memory region protection table entry (MRPTE) for defining access rights for the memory region, said MRPTE including one or more pointers to said one or more address translation tables;
binding a memory window to said memory region, said memory window providing access to a subset of said set of virtual addresses of the memory region;
using a memory window protection table entry (MWPTE) for defining access rights for the memory window; and
giving the MWPTE one or more pointers to said one or more address translation tables to translate said subset of virtual addresses to the real addresses associated with said subset of virtual addresses.

14. A program storage device according to claim 13, wherein said one or more address translation tables includes a first level address translation table and a second level address translation table, and further comprising the step of providing the MWPTE with a set of format bits for indicating whether the one or more pointers of the MWPTE point to either said first level address translation table or to said second level address translation table.

15. A program storage device according to claim 14, wherein said method steps comprise the further step of using said one or more pointers of the MWPTE to access said first level address translation table if said format bits have a first defined value.

16. A program storage device according to claim 15, wherein said method steps comprise the further step of using said one or more pointers of the MWPTE to access said second level address table if said format bits have a second defined value.

17. A program storage device according to claim 13, wherein:
said one or more address translation tables includes a first level address translation table and a second address translation table; and
said one or more pointers includes a first pointer pointing to the first translation table and a second pointer pointing to the second translation table.

18. A program storage device according to claim 13, wherein the method steps comprise the further step of adding to the MWPTE a base address of the memory region.
